(19) United States
(12) Patent Application Publication
(10) Pub. No.: US 2015/0120377 A1
(43) Pub. Date: Apr. 30, 2015

(54) MEASURING EFFICACY OF ERGONOMIC INTERVENTIONS

(71) Applicant: FUJITSU LIMITED, Kawasaki-shi (JP)

(72) Inventors: David L MARVIT, San Francisco, CA (US); Ajay CHANDER, San Francisco, CA (US); Jawahar JAIN, Los Altos, CA (US); Alex GILMAN, Fremont, CA (US)

(73) Assignee: FUJITSU LIMITED, Kawasaki-shi (JP)

(21) Appl. No.: 14/062,704

(22) Filed: Oct. 24, 2013

(51) Int. Cl. G06Q 30/02

(52) U.S. Cl. CPC G06Q 30/0201
USPC 705/7.29

(57) ABSTRACT

According to an aspect of an embodiment, a method of measuring efficacy of an ergonomic intervention includes tracking a utilization of the ergonomic intervention over time and storing the utilization of the ergonomic intervention over time. The method further includes tracking a state of a user of the ergonomic intervention over time and storing the state of the user over time. The method further includes calculating an efficacy measurement based at least in part on the utilization of the ergonomic intervention over time and the state of the user over time.

### FIELD

The embodiments discussed herein are related to measuring efficacy of ergonomic interventions.

### BACKGROUND

Businesses and individuals have become more aware of adverse health effects associated with workplaces. For example, sitting for long periods of time has been recognized as a potentially unhealthy behavior. Workers who spend large portions of their workdays sitting at a workstation such as a desk may experience adverse health effects such as disrupted metabolic functions, back pain, and the like. Workers may develop repetitive strain injuries (RSIs) through performing repetitive tasks, maintaining poor posture or awkward positions, and the like during the workday.

Ergonomic interventions may be introduced to workstations of the user to attempt to eliminate, or at least mitigate, the adverse health effects associated with the workplace. However, in many instances, the ergonomic interventions may be relatively expensive to introduce.

For example, adjustable workstations may mitigate adverse health effects associated with prolonged sitting by allowing a worker to vary their posture or be active as they work, but the adjustable workstations may be relatively expensive compared to conventional workstations. Examples of adjustable workstations include adjustable desks commonly described as sit-to-stand desks. Sit-to-stand desks may allow a relative height of a work surface of the desk to be selectively varied. A worker using a sit-to-stand desk may vary the height of the work surface to allow the worker to stand, sit, and otherwise vary their posture throughout the workday. Examples of adjustable workstations further include activity-enabling desks commonly described as walkstations. Walkstations incorporate a treadmill and/or other activity-enabling elements into a workstation. A worker using a walkstation may selectively utilize the treadmill and/or other activity-enabling elements and may adjust the rate and/or duration of their walking and/or other activities throughout the workday.

### SUMMARY

According to an aspect of an embodiment, a method of measuring efficacy of an ergonomic intervention includes tracking a utilization of the ergonomic intervention over time and storing the utilization of the ergonomic intervention over time. The method further includes tracking a state of a user of the ergonomic intervention over time and storing the state of the user over time. The method further includes calculating an efficacy measurement based at least in part on the utilization of the ergonomic intervention over time and the state of the user over time.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a diagrammatic view of a system of measuring efficacy of an ergonomic intervention;

FIG. 2 is a diagrammatic view of a system of measuring efficacy of multiple ergonomic interventions;

FIG. 3 is a diagrammatic view of a system of measuring efficacy of an adjustable workstation;

FIG. 4 is a flowchart of a method of measuring efficacy of an ergonomic intervention; and

FIG. 5 is a flowchart of a method of measuring efficacy of multiple ergonomic interventions.

### DESCRIPTION OF EMBODIMENTS

Employers are increasingly considering supplying ergonomic interventions to their employees. However, many ergonomic interventions may be relatively expensive. For example, adjustable workstations, such as sit-to-stand desks or walkstations, may be considerably more expensive than conventional, non-adjustable workstations. When considering whether to purchase and/or install ergonomic interventions, employers often have little information about whether the benefits of the ergonomic interventions sufficiently justify the expense of the ergonomic interventions.

Embodiments described herein may allow the efficacy of ergonomic interventions to be measured. Information about the efficacy of existing ergonomic interventions may help employers determine whether to invest in additional similar and/or identical ergonomic interventions for the same and/or additional employees. Furthermore, information about the efficacy of the ergonomic interventions may be used to identify characteristics of employees that are likely to benefit from the ergonomic intervention. The information about the efficacy of the ergonomic interventions may also be used to identify ways to improve employee health, employee productivity, economic intervention design, and the like.

Embodiments of the present invention will be explained with reference to the accompanying drawings.

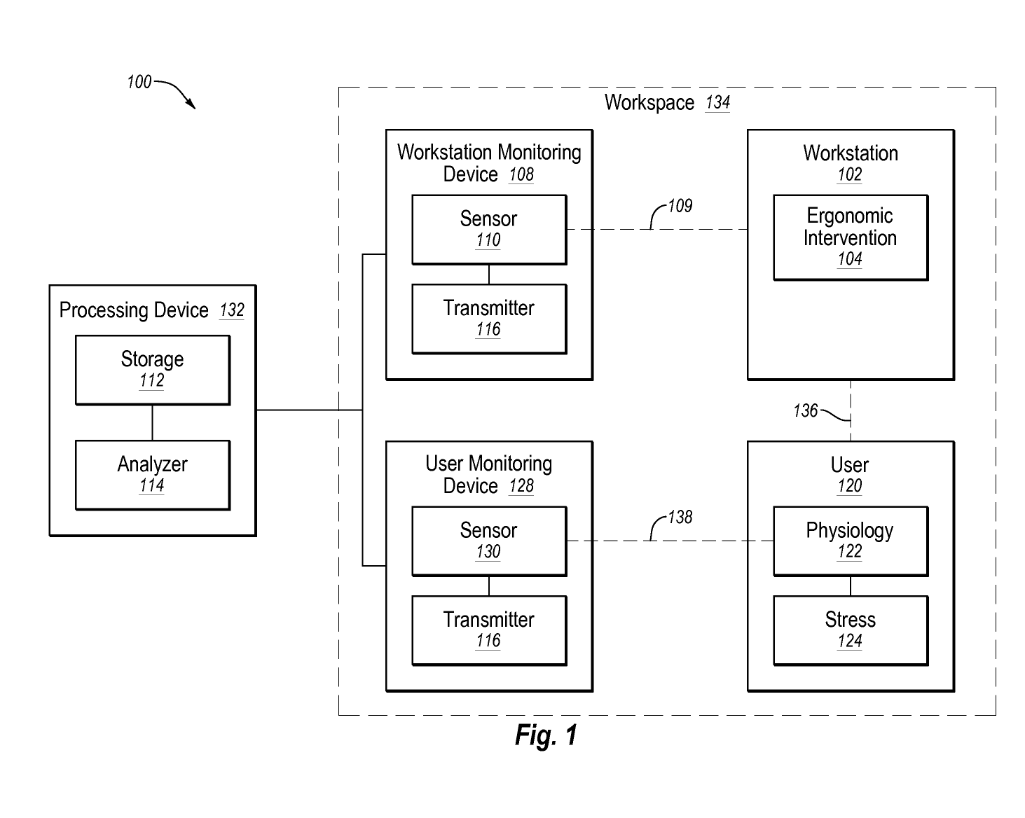

FIG. 1 is a diagrammatic view of a system 100 of measuring efficacy of an ergonomic intervention 104. The ergonomic intervention 104 may include a system, device, or the like to be used in a workstation 102 by a user 120 such that adverse health effects associated with a workspace 134 may potentially be mitigated. Examples of ergonomic interventions 104 may include augmented workstations 102 such as sit-to-stand desks, treadmill desks, and the like; sitting devices such as adjustable chairs, adjustable stools, Swiss balls, and the like; posture monitors; ergonomic equipment such as computer input devices, displays, phone headsets, and the like; ergonomic devices such as posture and other wearable monitors with feedback, and the like; monitoring and intervention software such as break reminder systems, and the like. The ergonomic intervention 104 may be provided to the user 120 by an employer of the user 120 such that the employer may study the efficacy of the ergonomic intervention 104. Alternately or additionally, the ergonomic intervention 104 may be purchased or otherwise obtained by the user 120 or may be provided by a manufacturer or supplier of the ergonomic intervention 104 or by a third party.

The workstation 102 may also include other equipment for use by the user 120. For example, the workstation 102 may include one or more desks, tables, sitting devices, computing devices, displays, computer input devices, tools, machinery, or the like or any combination thereof.

The system 100 may include a workstation monitoring device 108. The workstation monitoring device 108 includes a sensor 110 configured to sense utilization of the ergonomic intervention 104, as generally indicated by line 109. The sensor 110 and/or the workstation monitoring device 108 may be located on the ergonomic intervention 104. Alternately, the sensor 110 and/or the workstation monitoring device 108 may be located off the ergonomic intervention 104 and the sensor 110 may be suitably located to sense a utilization of the ergonomic intervention 104.

The sensor 110 may automatically track a utilization of the ergonomic intervention 104 over time, referred to herein as the tracked utilization of the ergonomic intervention 104. The sensor 110 may track the utilization of the ergonomic intervention 104 continuously or intermittently. The tracked utilization of the ergonomic intervention 104 may generally indicate when and how the user 120 interacts with the ergonomic intervention 104.

The sensor 110 may output a signal representing a sensed utilization of the ergonomic intervention 104 and a time the utilization was sensed. Alternately, the sensor 110 may output a signal representing a sensed utilization of the ergonomic intervention 104 and the signal may be associated with a time the utilization was sensed external to the sensor 110.

The sensor 110 type may depend on the purpose and/or the operation of the ergonomic intervention 104. For example, the sensor 110 may include an accelerometer, a microphone, a range finder, an image capturing device, a tactile sensor, a software-based monitor, or the like or any combination thereof. In some embodiments, the sensor may sense an output of the ergonomic intervention 104. For example, the ergonomic intervention 104 may monitor a posture of the user 120 and may provide the user 120 with a notification when the posture of the user 120 is potentially unhealthy. The sensor 110 may sense the state of the notification to sense the utilization of the ergonomic intervention 104. For example, the sensor 110 may sense when the user 120 is notified of an unhealthy posture and whether the user 120 improves his posture in response such that the notification goes away.

In some embodiments, the sensor 110 may track a state of the workstation 102 over time, referred to herein as a tracked state of the workstation 102. The state of the workstation 102 may vary over time according to the information sensed by the sensor 110.

The sensor 110 may include an accelerometer. The accelerometer may be located on the workstation 102. The accelerometer may measure movement of the workstation 102. The accelerometer may measure transitory movements of the workstation 102, such as small, temporary movements created while the user 120 is typing, writing, talking, or otherwise performing an activity at the workstation 102.

Alternately or additionally, the sensor 110 may include a microphone. The microphone may be located on or relatively near the workstation 102 such that the microphone may sense audible output of and/or around the workstation 102. The microphone may sense audible output made by the user 120, such as sounds of talking, writing, typing, and the like.

Alternately or additionally, the sensor 110 may include an image capturing device. The image capturing device may be positioned to optically sense visual output of and/or around the workstation 102. The image capturing device may optically sense visual output of the user 120, such as movement of the user 120, interaction with objects by the user 120, and the like.

Alternately or additionally, the sensor 110 may include an activity and/or productivity monitor to track activities and/or productivity of the user 120. For example, a computer usage sensor running on a computer (not shown) located at the workstation 102 may monitor computer activity of the user 120. The computer activity monitored may include keystroke activity, internet browsing activity, application usage activity, or the like. Computer activities monitored by the computer usage sensor may be used in tracking activities and/or productivity of the user 120 over time.

The workstation monitoring device 108 may include a transmitter 116. The transmitter 116 may include a wired transmitter 116 such as an optical or Ethernet transmitter 116. Alternately or additionally, the transmitter 116 may include a wireless transmitter 116 such as an IEEE 802.11 or Bluetooth transmitter 116. The transmitter 116 may transmit the tracked utilization of the ergonomic intervention 104, the tracked state of the workstation 102, and/or tracked activities and/or productivity of the user 120 from the sensor 110. Alternately or additionally, the transmitter 116 may transmit a raw data signal output by the sensor 110.

The user 120 may interact with the workstation 102 and/or the ergonomic intervention 104, as indicated by line 136. For example, the workstation 102 may be provided to the user 120 by an employer and the user 120 may interact with the workstation 102 and/or the ergonomic intervention 104 in the normal course of employment.

Generally, a stress 124 or other biological marker of the user may change as the user 120 interacts with the workstation 102 and/or the ergonomic intervention 104. Some of the changes in the stress 124 may be caused or otherwise encouraged by the workstation 102 and/or the ergonomic intervention 104. An increase in the stress 124 of the user 120 may be associated with an increase in fatigue of the user 120. Increased fatigue may lead to an increase in errors of the user 120, which may be associated with an increased risk of injuries or decreased productivity.

The stress 124 of the user 120 may affect a physiology 122 of the user in predictable and/or understandable ways. For example, the stress 124 may affect a heart rate, a heart rate variability, a blood pressure, a weight, a respiratory function, or other biological marker of the user 120, or the like or any combination thereof.

The system 100 includes a user monitoring device 128. The user monitoring device 128 includes a sensor 130. The sensor 130 may track a state of the user 120 over time, referred to herein as a tracked state of the user. The state of the user 120 may vary over time according to the information sensed by the sensor 130. The sensor 130 may sense the stress 124 and/or physiology 122 of the user 120, a movement of the user 120, a posture of the user 120, a facial expression of the user 120, computer activity of the user 120, or the like or any combination thereof.

In general, the sensor 130 may be suitably located to sense the state of the user 120, as indicated by line 138. For instance, the sensor 130 and/or the user monitoring device 128 may be located on the user 120. For example, the sensor 130 may be worn by the user 120. Alternately, the user monitoring device 128 and/or the sensor 130 may be located off the user 120 and the sensor 130 may be suitably located to sense the state of the user 120.

In some embodiments, the user monitoring device 128 may track the state of the user 120 after the user 120 has left the workspace 134. For example, the user monitoring device 128 may track the state of the user 120 when the user 120 is at lunch, at home, or otherwise away from the workspace 134.

In some embodiments, the user monitoring device 128 may include a storage configured to store the tracked state of the user 120. The storage may store the tracked state of the user 120 at times that the transmitter 116 is unable to transmit the tracked state of the user 120.

The system 100 may include a processing device 132. The processing device 132 may receive the tracked utilization of the ergonomic intervention 104, the tracked state of the workstation 102, and/or the tracked state of the user 120. The processing device 132 may include a computing device (not shown) located at the workstation 102. In some embodiments, the computing device may be the computing device used by the user 120 of the workstation 102.

Alternately or additionally, the processing device 132 may include a system for collecting and analyzing, for each of multiple workspaces generally corresponding to the workspace 134, the tracked utilization of the corresponding ergonomic intervention 104, the tracked state of the corresponding workstation 102, and/or the tracked state of the corresponding user 120. For example, the processing device 132 may include a computer, server, or other system for an employer to collect, store and analyze some or all of the foregoing data and/or other data.

The processing device 132 includes a storage 112. The storage 112 may store the tracked utilization of the ergonomic intervention 104, the tracked state of the workstation 102, and/or the tracked state of the user 120. The storage 112 may include any suitable tangible or non-transitory computer-readable storage media, including volatile and/or non-volatile computer-readable storage media.

The processing device 132 may additionally include an analyzer 114. The analyzer 114 may calculate an efficacy measurement of the ergonomic intervention 104. The efficacy measurement may be based on the tracked utilization of the ergonomic intervention 104, the tracked state of the workstation 102, and/or the tracked state of the user 120. In some embodiments, the efficacy measurements may be stored in the storage 112. Alternately or additionally, the processing device 132 may include a transmitter generally such as the transmitter 116 of the workstation monitoring device 108 and may transmit the efficacy measurements to another device.

In some embodiments, the analyzer 114 may determine activities of the user 120 over time based on the tracked state of the workstation 102. Alternately or additionally, the workstation monitoring device 108 may determine activities of the user 120 over time based on the tracked state of the workstation and may transmit the activities of the user 120 over time to the processing device 132. The efficacy measurement may be further based on the activities of the user 120 over time.

Activities of the user may include reading, typing, writing, interacting with a computer via a computer mouse or other input device, conversing with another person via telephone, conversing with another person near the workstation 102, manufacturing, sleeping, and the like. The analyzer 114 may further determine whether the activity contributes to the productivity of the user. For example, the productivity of the activity may be determined by analyzing the state of the workstation 102 sensed by a computer usage sensor, as described above.

In some embodiments, the analyzer 114 may determine the stress 124 of the user 120 over time based on the tracked state of the user 120. For example, the analyzer 114 may determine the stress 124 of the user 120 over time based on the tracked physiology 122 of the user 120. Alternately or additionally the user monitoring device 128 may determine the stress 124 of the user 120 over time based on the tracked state of the user 120 and may transmit the stress 124 of the user 120 over time to the processing device 132.

In some embodiments, the efficacy measurements may include correlating the utilization of the ergonomic intervention 104 with a change of the state of the user 120. Correlation methods such as Pearson's correlation and the like may be used to determine correlation. The utilization of the ergonomic intervention 104 may be correlated to a change in the physiology 122 and/or the stress 124 of the user 120. For example, the utilization of the ergonomic intervention 104 may be correlated to a change in a heart rate of the user 120, a heart rate variability of the user 120, a blood pressure of the user 120, a weight of the user 120, and/or a respiratory function of the user 120, or the like or any combination thereof.

In some embodiments, the efficacy measurement may include an effectiveness of the ergonomic intervention 104 in reducing the stress 124 of the user 120. Alternately or additionally, the efficacy measurement may include a correlation between an extent the user 120 utilizes the ergonomic intervention 104 and an extent the stress 124 is reduced. Alternately or additionally, the efficacy measurement may include a length of time that the stress 124 of the user 120 remains reduced following utilization of the ergonomic intervention 104. Alternately or additionally, the efficacy measurement may include a correlation between utilization of the ergonomic intervention 104 and changes in the physiology 122 of the user 120, such as a heart rate of the user 120, a heart rate variability of the user 120, a blood pressure of the user 120, a weight of the user 120, a respiratory function of the user 120, and/or other physiological measurements/biological markers of interest.

In some embodiments, the processing device 132 may further receive organizational metrics of the user 120. Organizational metrics of the user 120 may include absenteeism of the user 120 over time, presenteeism of the user 120 over time, productivity of the user 120 over time, satisfaction of the user 120 over time, or the like or any combination thereof. The organizational metrics may be determined from the tracked state of the workstation 102 and/or the tracked state of the user 120. Alternately or additionally, the organizational metrics may be tracked by an employer of the user 120, or the like. Alternately or additionally, the organizational metrics may be determined through surveys of the user 120 over time.

The efficacy measurement may include a correlation between the extent the user 120 utilizes the ergonomic intervention 104 and a change in the organizational metrics of the user 120, such as absenteeism of the user 120, presenteeism of the user 120, productivity of the user 120, satisfaction of the user 120, and/or other organizational metrics of interest.

Modifications, additions, or omissions may be made to FIG. 1 without departing from the scope of the described embodiments. For example, although only a single sensor 110 is illustrated, in other embodiments the workstation monitoring device 108 may include multiple sensors 110. Alternately or additionally, efficacy measurements may be determined for the ergonomic intervention 104 across multiple users generally corresponding to the user 120 and multiple workstations generally corresponding to the workstation 102.

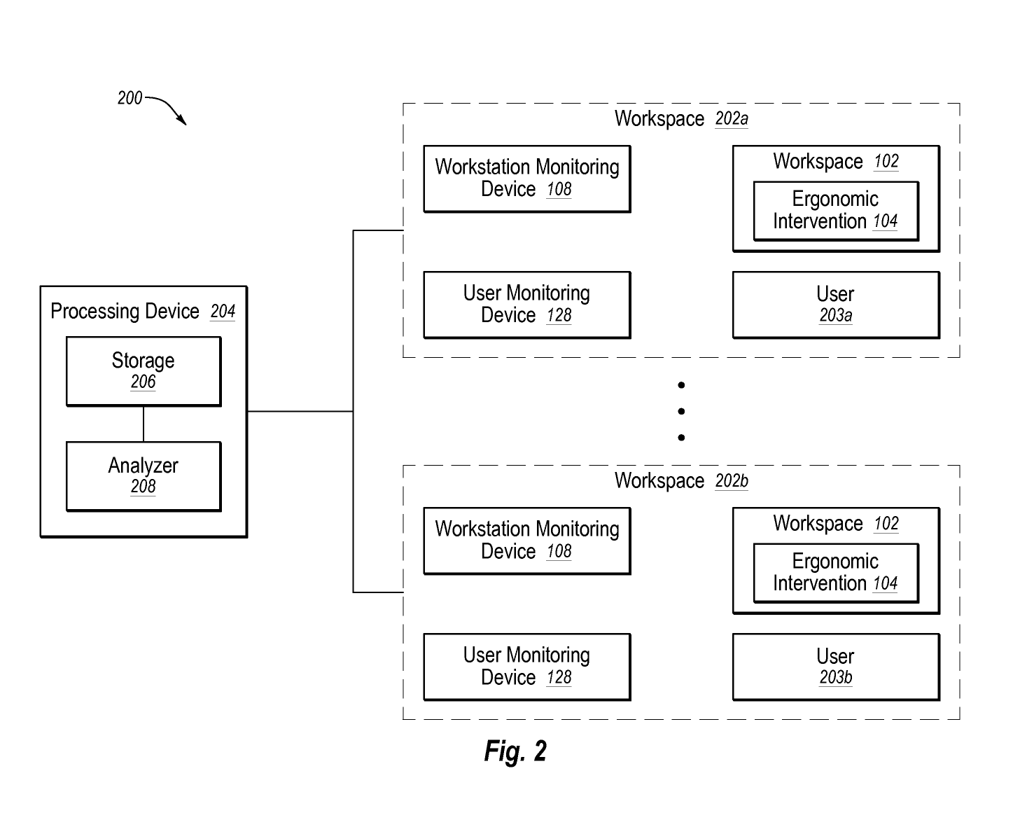

FIG. 2 is a diagrammatic view of a system 200 of measuring efficacy of multiple ergonomic interventions 104. The system 200 may include multiple workspaces generally corresponding to the workspace 134 of FIG. 1, as indicated by workspace 202a through workspace 202b (collectively “multiple workspaces 202”). The multiple workspaces 202 may each include some elements that are similar or identical to the elements of the workspace 134 of FIG. 1, such as the workstation 102, the workstation monitoring device 108, and the user monitoring device 128, for which a more detailed description is provided above. The multiple workspaces 202 may each include a user generally corresponding to the user 120 of FIG. 1, as indicated by user 203a through user 203b (collectively “users 203”).

The system 200 may include a processing device 204, which may generally correspond to the processing device 132 of FIG. 1. The processing device 204 may receive the tracked utilization of the ergonomic intervention 104, the tracked state of the workstation 102, and/or the tracked state of the users 203. The processing device 204 may include a storage 206 and an analyzer 208.

The storage 206 may generally correspond to the storage 112 of FIG. 1. The storage 206 of FIG. 2 may store tracked utilizations of the ergonomic interventions 104, tracked states of the workstations 102, and/or tracked states of the users 203.

The analyzer 208 may generally correspond to the analyzer 114 of FIG. 1. The analyzer 208 of FIG. 2 may calculate efficacy measurements for the ergonomic interventions 104 in a manner generally corresponding to the analyzer 114 of FIG. 1 and across the users 203 of the multiple workspaces 202.

The analyzer 208 may calculate the efficacy measurements in real-time or near real-time. For example, the system 200 may determine and display efficacy measurements, utilization of the ergonomic intervention 104, health measurements of the users 203, and the like such that a member of an organization may observe the information in real-time or near real-time.

In some embodiments, the processing device 204 may receive characteristics of the users 120 of the multiple workstations 202. The analyzer 208 may calculate the efficacy measurement based on characteristics of the users 203. The characteristics of the users 203 may include ages of the users 203, genders of the users 203, health conditions of the users 203, and/or other characteristics of interest.

Calculating the efficacy measurement may include correlating an effectiveness of the ergonomic intervention 104 with characteristics of the users 203. For example, the effectiveness of the ergonomic intervention 104 in reducing stress may be correlated to one or more characteristics of the users 203.

The analyzer 208 may determine particular characteristics of the users 203 correlated with an effectiveness of the ergonomic intervention 104 in improving one or more metrics of interest. Metrics of interest may include absenteeism, presenteeism, stress reduction, satisfaction, health, physiology, productivity, and/or other metrics that, if improved, would provide a benefit to the users 203 and/or an employer of the users 203.

The characteristics correlated with the effectiveness of the ergonomic intervention 104 in improving the one or more metrics of interest may be used by an employer to identify employees most likely to improve the one or more metrics of interest by using the ergonomic intervention 104. Advantageously, the employer may deploy its resources in some embodiments so as to provide the ergonomic intervention 104 to the employees that are likely to provide the largest benefit to the employer.

In some embodiments, the analyzer 208 may determine the characteristics at least in part using a machine learning technique for supervised learning. For each metric of interest, supervised learning may be performed to identify subsets of characteristics that are most predictive of experiencing a high benefit on the metric.

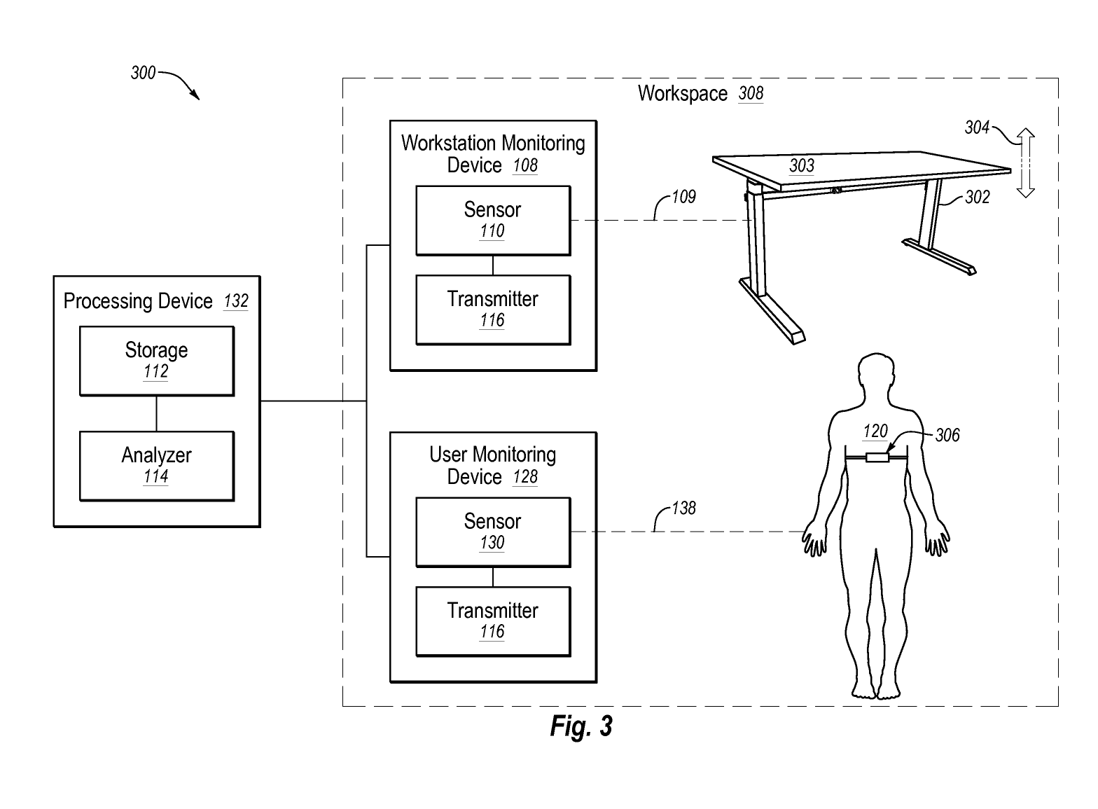

FIG. 3 is a diagrammatic view of a system 300 of measuring efficacy of an adjustable workstation 302. The system 300 includes some elements that are similar or identical to elements of the system 100 of FIG. 1, such as the user 120, the workstation monitoring device 108, the sensor 110, the transmitter 116, the user monitoring device 128, the sensor 130, the processing device 132, the storage 112, and the analyzer 114, for which a more detailed description is already provided above.

The system may include a workspace 308 generally corresponding to the workspace 134 of FIG. 1. The user 120 is shown as wearing a wearable sensor 306, generally corresponding to the sensor 130. The wearable sensor 306 may sense a heart rate of the user 120, a heart rate variability of the user 120, a respiratory function of the user 120, or the like or in any combination thereof.

The adjustable workstation 302 may generally correspond to both the workstation 102 and the ergonomic intervention 104 of FIG. 1. The adjustable workstation 302 may mitigate adverse health effects associated with prolonged sitting by allowing the user 120 to vary their posture as they work. Thus, the adjustable workstation 302 corresponds to both the workstation 102 and the ergonomic intervention 104 of FIG. 1.

The adjustable workstation 302 may include a work surface 303. Although not shown, the adjustable workstation 302 may include equipment to be used by a user of the adjustable workstation 302. For example, the adjustable workstation 302 may include one or more computing devices, displays, computer input devices, tools, machinery, or the like or any combination thereof.

The adjustable workstation 302 may be selectively arranged by making adjustments 304 to the adjustable workstation 302. For example, adjustments 304 may be made to increase and/or decrease a relative height of the work surface 303. Alternately or additionally, adjustments 304 may be made to operate an activity-enabling element of the adjustable workstation 302, such as turning a treadmill on or off, or changing a rate or incline of the treadmill. Alternately or additionally, the adjustable workstation 302 may be configured to make other types of adjustments 304 such as tilting the work surface 303, moving separate portions of the work surface 303 relative to one another, or the like. A user working at the adjustable workstation 302 may make adjustments 304 to the adjustable workstation 302 to allow the worker to sit, stand, walk, or otherwise vary their posture while at the adjustable workstation 302. Alternately or additionally, adjustments 304 may be made automatically, e.g., by a controller or processor in communication with and/or included in the adjustable workstation.

In some embodiments, the adjustable workstation 302 may include a conventional sit-to-stand desk or a conventional walkstation. Alternately, another type of adjustable workstation 302 may be used.

As described above, the sensor 110 may track utilization of the adjustable workstation 302 over time and a state of the adjustable workstation 302 over time.

As described above, the sensor 110 may include an accelerometer. The accelerometer may be located on the adjustable workstation 302. The accelerometer may measure movement of the adjustable workstation 302. In some embodiments, the accelerometer measures adjustments 304 of the adjustable workstation 302. For example, movements measured by the accelerometer may be integrated to determine placements of the adjustable workstation 302. The determined adjustments 304 may be used to identify arrangements of the adjustable workstation 302 selected by the user of the adjustable workstation 302, referred to herein as selected arrangements of the adjustable workstation 302. Selected arrangements may include selected positions of the adjustable workstation 302, selected operations of an activity-enabling element of the adjustable workstation 302, or the like or any combination thereof. The adjustments 304 and the selected arrangements of the adjustable workstation 302 may be tracked as utilization of the adjustable workstation 302.

The accelerometer may alternately or additionally measure transitory movements of the adjustable workstation 302, such as small, temporary movement created while a user is typing, writing, talking, or otherwise performing an activity at the adjustable workstation 302. The transitory movements of the adjustable workstation 302, as well as other information about the adjustable workstation 302 not related to the adjustments 304 and/or selected arrangements of the adjustable workstation 302 may be tracked as a state of the adjustable workstation 302.

As described above, the sensor 110 may alternately or additionally include a microphone. The microphone may be located on or sufficiently near the adjustable workstation 302 such that the microphone may sense audible output of the adjustable workstation 302. The microphone may sense audible output made by a user of the adjustable workstation 302, such as sounds of talking, writing, typing, and the like.

The microphone may also sense audible output of the adjustable workstation 302, such as sounds of motors used to make adjustments 304 to the adjustable workstation 302. Characteristics of the audible output may indicate the adjustments 304 that are occurring. For example, if the adjustable workstation 302 is being selectively positioned and the velocity of the adjustments 304 is known through the sensor 110 or otherwise, durations of the audible output may be used to measure the adjustments 304 and determine the selected positions of the adjustable workstation 302.

Alternately or additionally, the sensor 110 may include a range finder. The range finder may be located on the adjustable workstation 302, and in particular on a movable surface or component of the adjustable workstation 302, and may sense a distance between the adjustable workstation 302 and a fixed surface. Alternately, the range finder may be located on a fixed surface and may sense a distance between the fixed surface and the adjustable workstation 302, or more particularly between the fixed surface and a movable surface or component of the adjustable workstation 302. The range finder may measure adjustments 304 of the adjustable workstation 302 by measuring changes in the distance between the fixed surface and the adjustable workstation 302. For example, the sensed distances between the fixed surface and the adjustable workstation 302 may be used to determine the selected positions of the adjustable workstation 302.

As described above, the sensor 110 may alternately or additionally include an image capturing device. The image capturing device may be positioned to optically sense visual output of the adjustable workstation 302. The image capturing device may optically sense visual output of a user of the adjustable workstation 302, such as movement of the user, user interaction with objects, and the like. The image capturing device may optically sense the selected arrangements of the adjustable workstation 302 and/or adjustments 304 of the adjustable workstation 302. The selected arrangements of the adjustable workstation 302 and/or the adjustments 304 of the adjustable workstation 302 may be determined by optically sensing the adjustable workstation 302 placements and/or movements relative to the environment of the adjustable workstation 302.

Computer vision may be used to sense the visual output of the adjustable workstation 302. For example, computer vision algorithms such as object recognition and movement detection may be used to recognize the adjustable workstation 302 and sense the placements and/or movements of the adjustable workstation 302 at times when adjustments 304 are made to the adjustable workstation 302. In some embodiments, the image capturing device may conserve resources of the workstation monitoring device 108 by outputting frames of captured images when adjustments 304 are being made to the adjustable workstation 302, but may refrain from outputting captured images when adjustments 304 are not being made.

As described above, the sensor 110 may alternately or additionally include an activity and/or productivity monitor to track activities and/or productivity of a user of the adjustable workstation 302. For example, a computer usage sensor running on a computer (not shown) located at the adjustable workstation 302 may monitor computer activity of the user of the adjustable workstation 302. The computer activity monitored may include keystroke activity, internet browsing activity, or the like. Computer activities monitored by the computer usage sensor may be used in tracking activities and/or productivity of the user of the adjustable workstation 302 over time.

Efficacy measurements of the adjustable workstation 302 may be performed in a manner generally corresponding to the calculation of efficacy measurements of the ergonomic intervention 104 of FIGS. 1 and 2.

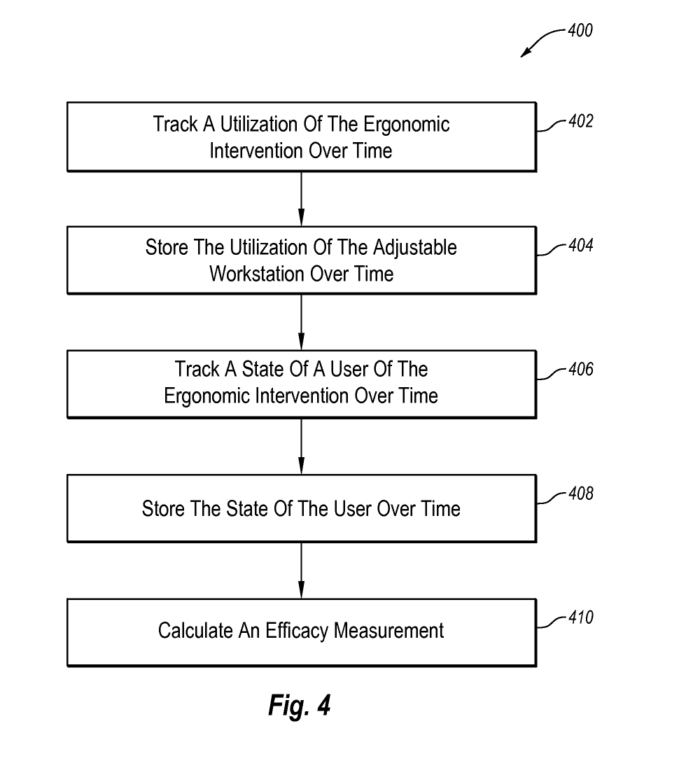

FIG. 4 is a flowchart of a method 400 of measuring efficacy of an ergonomic intervention. The ergonomic intervention may generally correspond to the ergonomic intervention 104 of FIGS. 1-2, for example. The method 400 may be performed, in some embodiments, by a workstation monitoring device, a user monitoring device, and a processing device, such as the workstation monitoring device 108, the user monitoring device 128, and the processing devices 132 and 204 of FIGS. 1-3, for example.

The method 400 may begin at block 402 by tracking a utilization of the ergonomic intervention over time. In some embodiments, tracking the utilization of the ergonomic intervention over time may be performed by a sensor, such as the sensor 110 of FIGS. 1-3.

In some embodiments, tracking utilization of the ergonomic intervention over time includes tracking the state of an adjustable workstation over time. The adjustable workstation may be configured to be selectively arranged. Tracking the utilization of the adjustable workstation may include tracking adjustments to the adjustable workstation.

The method 400 may continue at block 404 by storing the utilization of the ergonomic intervention over time. In some embodiments, storing the utilization of the ergonomic intervention over time may be performed by a storage, such as the storage 112 and 206 of FIGS. 1-3.

The method 400 may continue at block 406 by tracking a state of a user of the ergonomic intervention over time. In some embodiments, tracking the state of the user of the ergonomic intervention over time may be performed by a sensor, such as the sensor 130 of FIGS. 1-3.

In some embodiments, tracking the state of the user over time includes sensing a physiology of the user over time. Sensing the physiology of the user over time may include sensing one of a heart rate, a heart rate variability, a blood pressure, a weight and a respiratory function. Tracking the state of the user over time may further include determining stress of the user over time based at least in part on the physiology of the user over time.

The method 400 may continue at block 408 by storing the state of the user over time. In some embodiments, storing the state of the user over time may be performed by a storage, such as the storage 112 and the storage 206 of FIGS. 1-3.

The method 400 may continue at block 410 by calculating an efficacy measurement. The efficacy measurement may be based at least in part on the utilization of the ergonomic intervention over time and the state of the user over time. In some embodiments, calculating the efficacy measurement may be performed by an analyzer such as the analyzer 114 and the analyzer 208 of FIGS. 1-3.

In some embodiments, calculating the efficacy measurement includes correlating the utilization of the ergonomic intervention over time with a change of the state of the user. Alternately or additionally, calculating the efficacy measurement may include correlating the utilization of the ergonomic intervention with a change of the physiology of the user. Alternately or additionally, calculating the efficacy measurement may include correlating the utilization of the ergonomic intervention with a change of the stress of the user.

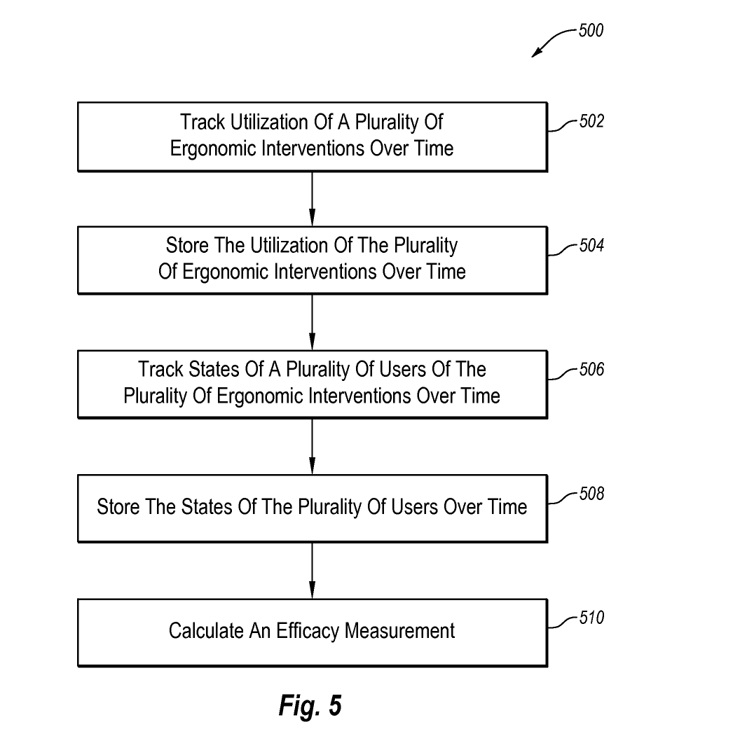

FIG. 5 is a flowchart of a method 500 of measuring efficacy of an ergonomic intervention. The ergonomic intervention may generally correspond to the ergonomic intervention 104 of FIGS. 1-2, for example. The method 500 may be performed, in some embodiments, by workstation monitoring devices, user monitoring devices, and a processing device, such as the workstation monitoring device 108, the user monitoring device 128, and the processing devices 132 and 204 of FIGS. 1-3, for example.

The method 500 may begin at block 502 by tracking a utilization of a plurality of ergonomic interventions over time. In some embodiments, tracking the utilization of the plurality of ergonomic interventions over time may be performed by a plurality of sensors, each similar to the sensor 110 of FIGS. 1-3.

The method 500 may continue at block 504 by storing the utilization of the plurality of ergonomic interventions over time. In some embodiments, storing the utilization of the plurality of ergonomic interventions over time may be performed by a storage, such as the storage 112 and 206 of FIGS. 1-3.

The method 500 may continue at block 506 by tracking states of a plurality of users of the plurality of ergonomic interventions over time. In some embodiments, tracking the states of the plurality of users of the plurality of ergonomic interventions over time may be performed by a plurality of corresponding sensors, each similar to the sensor 130 of FIGS. 1-3.

The method 500 may continue at block 508 by storing the states of the plurality of users over time. In some embodiments, storing the states of a plurality of users over time may be performed by a storage, such as the storage 112 and the storage 206 of FIGS. 1-3.

The method 500 may continue at block 510 by calculating an efficacy measurement. The efficacy measurement may be based at least in part on the utilization of the plurality of ergonomic interventions over time and the states of the plurality of users over time. In some embodiments, calculating the efficacy measurement may be performed by an analyzer such as the analyzer 114 and the analyzer 208 of FIGS. 1-3.

In some embodiments, calculating the efficacy measurement includes correlating an effectiveness of the ergonomic intervention with characteristics of the plurality of users.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For example, in some embodiments, the method 500 may further include determining a particular characteristic of the plurality of users correlated with an effectiveness of the ergonomic intervention in improving a metric of interest. In some embodiments, the metric of interest may include one of absenteeism, presenteeism, stress reduction, user satisfaction, productivity and user health.

The embodiments described herein may include the use of a special purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include tangible and/or non-transitory computer-readable storage media including random-access memory (RAM), read-only memory (ROM), electrically erasable programmable read-only memory (EEPROM), compact disc read-only memory (CD-ROM) or other optical disk storage, magnetic disk storage or other magnetic storage devices, or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions include, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” may refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it should be understood that the various changes, substitutions, and alterations could be made hereto without departing from the spirit and scope of the invention.

What is claimed is:

1. A method of measuring efficacy of an ergonomic intervention, the method comprising:
tracking a utilization of the ergonomic intervention over time;
storing the utilization of the ergonomic intervention over time;
tracking a state of a user of the ergonomic intervention over time;
storing the state of the user over time; and
calculating an efficacy measurement based at least in part on the utilization of the ergonomic intervention over time and the state of the user over time.

2. The method of claim 1, wherein calculating the efficacy measurement includes correlating the utilization of the ergonomic intervention over time with a change of the state of the user.

3. The method of claim 1, further comprising:
tracking a state of a workstation of the user over time, and
determining an activity of the user over time based at least in part on the state of the workstation over time.

4. The method of claim 1, wherein tracking the state of the user over time includes sensing a physiology of the user over time.

5. The method of claim 4, wherein calculating the efficacy measurement includes correlating the utilization of the ergonomic intervention with a change of the physiology of the user.

6. The method of claim 4, wherein tracking the state of the user over time includes determining stress of the user over time based at least in part on the physiology of the user over time.

7. The method of claim 6, wherein calculating the efficacy measurement includes correlating the utilization of the ergonomic intervention with a change of the stress of the user.

8. The method of claim 4, wherein sensing the physiology of the user over time includes sensing one of a heart rate, a heart rate variability, a blood pressure, a weight, and a respiratory function.

9. The method of claim 1, wherein calculating the efficacy measurement includes correlating the utilization of the ergonomic intervention with a change of one of absenteeism, presenteeism, productivity, and satisfaction of the user.

10. The method of claim 1, wherein tracking utilization of the ergonomic intervention over time includes tracking the state of an adjustable workstation over time, the adjustable workstation configured to be selectively arranged, and tracking the utilization of the adjustable workstation includes tracking adjustments to the adjustable workstation.

11. A system of measuring efficacy of an adjustable workstation, the system comprising:
a first sensor configured to automatically track a state of the adjustable workstation over time, the adjustable workstation configured to be selectively arranged;
a second sensor configured to automatically track a state of a user of the adjustable workstation over time;
a storage configured to store the state of the adjustable workstation over time, and the state of the user over time; and
a processing device configured to calculate an efficacy measurement based at least in part on the state of the adjustable workstation over time and the state of the user over time.

12. The system of claim 11, wherein the efficacy measurement includes a correlation of a change of the state of the adjustable workstation with a change of the state of the user.

13. The system of claim 11, wherein the state of the adjustable workstation includes an activity of the user.

14. The system of claim 11, wherein the second sensor is configured to sense the physiology of the user, including one of a heart rate of the user, a heart rate variability of the user, a blood pressure of the user, a weight of the user, and a respiratory function of the user.

15. The system of claim 14, wherein:
the state of the user includes stress of the user based at least in part on the physiology of the user, and
the efficacy measurement includes a correlation of the state of the adjustable workstation with a change of the stress of the user.

16. The system of claim 11, wherein the processing device is further configured to calculate the efficacy measurement based at least in part on an organization metric of the user over time, including one of absenteeism, presenteeism, productivity, and satisfaction of the user.

17. A method of measuring efficacy of an ergonomic intervention, the method comprising:
tracking utilization of a plurality of ergonomic interventions over time;
storing the utilization of the plurality of ergonomic interventions over time;
tracking states of a plurality of users of the plurality of ergonomic interventions over time;
storing the states of the plurality of users over time; and
calculating an efficacy measurement based at least in part on the utilization of the plurality of ergonomic interventions over time and the states of the plurality of users over time.

18. The method of claim 17, wherein calculating the efficacy measurement further includes correlating an effectiveness of the ergonomic intervention with characteristics of the plurality of users.

19. The method of claim 18, wherein the method further comprises determining a particular characteristic of the plurality of users correlated with an effectiveness of the ergonomic intervention in improving a metric of interest.

20. The method of claim 19, wherein the metric of interest includes one of absenteeism, presenteeism, stress reduction, user satisfaction, productivity and user health.
